(19) United States
(12) Patent Application Publication
(10) Pub. No.: US 2026/0238018 A1
(43) Pub. Date: Aug. 13, 2026

(54) System and Method for AI-Based Energy Management in Distributed Energy System

(71) Applicant: EnerSys Delaware Inc., Reading, PA (US)

(72) Inventors: Sifat Shahriar Khan, Arlington, VA (US); Arup Kanti Dey, Warren, MI (US); Enrico Pietrantozzi, Gambellara (IT)

(21) Appl. No.: 19/049,185

(22) Filed: Feb. 10, 2025

(51) Int. Cl. H02J 3/46; G05B 13/02; H02J 3/00; H02J 3/28; H02J 13/00

(52) U.S. Cl. CPC H02J 3/466; G05B 13/027; H02J 3/003; H02J 3/004; H02J 3/28; H02J 13/12; H02J 2101/24; H02J 2103/30; H02J 2103/35

(57) ABSTRACT

A method, computer program product, and computing system for receiving energy input data from a plurality of microgrid sources, using a prediction and forecasting platform to apply a combination of neural network models to the energy input data to generate an input set of energy forecast data, and feeding the input data set into a deep reinforcement learning (DRL) platform including a real-time agent, a scheduling agent, and a demand response (DR) agent. The method/product/system may further include creating a schedule for load balancing activities in a microgrid and for utilization of an energy storage system (ESS) in an upcoming time window, and updating decisions for load balancing activities in the microgrid and for utilization of the ESS, on a recurring basis. In response to a DR event, the method/product/system may further include governing decisions for curtailment handling activities performed in the microgrid for the duration of the DR event.

### BACKGROUND

Distributed energy resources also known as distributed power systems, microgrids, smart grids, distributed local energy networks, etc., are small-scale power grids that can operate independently from the main power grid, and provide a reliable and resilient source of power for communities, institutions, and industrial complexes. Such systems are typically connected to the main grid and consist of several key components, including power generators, energy storage systems (ESS), and power distribution networks.

The energy industry is continually looking for new approaches for how best to reduce energy consumption and costs while simultaneously improving energy efficiency. Hence, the emergence of energy management systems (EMS), which are powerful tools designed to monitor, control, and optimize energy usage in distributed power systems. The EMS system described herein represents another step toward accomplishing this goal.

### SUMMARY OF DISCLOSURE

In one example implementation, a computer-implemented method executed on a computing device may include, but is not limited to, receiving energy input data from a plurality of microgrid sources, using a prediction and forecasting platform to apply a combination of neural network models to the received energy input data in order to generate an input set of energy forecast data, and feeding the generated input set of energy forecast data into a deep reinforcement learning (DRL) platform including a real-time agent, a scheduling agent, and a demand response (DR) agent. The method may further include using the scheduling agent to create a schedule for load balancing activities in a microgrid and for utilization of an energy storage system (ESS) in an upcoming time window, and using the real-time agent to update decisions for load balancing activities in the microgrid and for utilization of the ESS, on a recurring basis after a first predefined time period passes. In response to a DR event, the method may further include using the DR agent to govern decisions for curtailment handling activities performed in the microgrid for the duration of the DR event.

One or more of the following example features may be included. The plurality of microgrid sources may include the ESS, a plurality of electric-vehicle (EV) charging stations, a plurality of solar photovoltaic (PV) panels, one or more facility buildings, and a connection to a primary power grid. The input set of energy forecast data may include EV charging demand data, facility usage forecast data, solar PV power generation forecast data, ESS remaining useful life (RUL) prediction data, and electricity price data. The EV charging demand data may be subdivided into: (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory-recurrent neural network (LSTM-RNN) deep learning (DL) technique to forecast how many cars will attempt to charge in the upcoming time-window, and how much power will be demanded by them. The facility usage forecast data may be subdivided into: (i) real-time facility power demand data obtained from one or more smart meters installed in the facility configured to provide real-time data on energy usage of the facility, and (ii) forecasted facility power demand data generated by applying a second LSTM-RNN DL technique to historical facility energy usage data. The solar PV power generation forecast data may be subdivided into: (i) real-time solar PV power generation data obtained from one or more inverters connected to the plurality of solar PV panels, and (ii) forecasted solar PV power generation data generated by applying a third LSTM-RNN DL technique to historical solar PV power generation data. The ESS remaining useful life (RUL) prediction data may be subdivided into: (i) ESS capacity degradation estimation data generated by using a second ANN ML model to estimate a battery capacity degradation cycle for each discharge cycle, and (ii) ESS RUL prediction data generated by a fourth LSTM-RNN DL technique to historical ESS capacity degradation data. The electricity price data may be subdivided into: (i) real-time electricity price data obtained from the primary power grid on a recurring basis after a second predefined time period passes, (ii) upcoming electricity price forecast data generated at least once a day for the upcoming time window based on historical electricity price data, and (iii) demand response event data received from the primary power grid via one or more application programming interfaces (APIs). Each agent in the deep reinforcement learning (DRL) platform may be configured to apply a combination of deep learning (DL) and reinforcement learning (RL) machine learning (ML) techniques. Each agent may be trained to make decisions by continuously interacting with an environment. Each agent may start with a random policy and may receive either positive or negative feedback for every action taken by the agent. Each agent may be configured to maximize positive feedback and to minimize negative feedback. Each action taken by one of the agents in the DRL platform may be framed as a Markov decision process (MDP).

In another example implementation, a computer program product resides on a computer readable medium that has a plurality of instructions stored on it. When executed by a processor, the instructions may cause the processor to perform operations that include, but are not limited to, receiving energy input data from a plurality of microgrid sources, using a prediction and forecasting platform to apply a combination of neural network models to the received energy input data in order to generate an input set of energy forecast data, and feeding the generated input set of energy forecast data into a deep reinforcement learning (DRL) platform including a real-time agent, a scheduling agent, and a demand response (DR) agent. The instructions may further include using the scheduling agent to create a schedule for load balancing activities in a microgrid and for utilization of an energy storage system (ESS) in an upcoming time window, and using the real-time agent to update decisions for load balancing activities in the microgrid and for utilization of the ESS, on a recurring basis after a first predefined time period passes. In response to a DR event, the instructions may further include using the DR agent to govern decisions for curtailment handling activities performed in the microgrid for the duration of the DR event.

One or more of the following example features may be included. The plurality of microgrid sources may include the ESS, a plurality of electric-vehicle (EV) charging stations, a plurality of solar photovoltaic (PV) panels, one or more facility buildings, and a connection to a primary power grid. The input set of energy forecast data may include EV charging demand data, facility usage forecast data, solar PV power generation forecast data, ESS remaining useful life (RUL) prediction data, and electricity price data. The EV charging demand data may be subdivided into: (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory-recurrent neural network (LSTM-RNN) deep learning (DL) technique to forecast how many cars will attempt to charge in the upcoming time-window, and how much power will be demanded by them. Each agent in the deep reinforcement learning (DRL) platform may be configured to apply a combination of deep learning (DL) and reinforcement learning (RL) machine learning (ML) techniques. Each agent may be trained to make decisions by continuously interacting with an environment. Each agent may start with a random policy and may receive either positive or negative feedback for every action taken by the agent. Each agent may be configured to maximize positive feedback and to minimize negative feedback.

In another example implementation, a computing system includes at least one processor and at least one memory architecture coupled with the at least one processor, where the at least one processor may be configured to use a prediction and forecasting platform to apply a combination of neural network models to the received energy input data in order to generate an input set of energy forecast data, and to feed the generated input set of energy forecast data into a deep reinforcement learning (DRL) platform including a real-time agent, a scheduling agent, and a demand response (DR) agent. The processor may also use the scheduling agent to create a schedule for load balancing activities in a microgrid and for utilization of an energy storage system (ESS) in an upcoming time window, use the real-time agent to update decisions for load balancing activities in the microgrid and for utilization of the ESS, and on a recurring basis after a first predefined time period passes. In response to a DR event, the processor may also use the DR agent to govern decisions for curtailment handling activities performed in the microgrid for the duration of the DR event.

One or more of the following example features may be included. The plurality of microgrid sources may include the ESS, a plurality of electric-vehicle (EV) charging stations, a plurality of solar photovoltaic (PV) panels, one or more facility buildings, and a connection to a primary power grid. The input set of energy forecast data may include EV charging demand data, facility usage forecast data, solar PV power generation forecast data, ESS remaining useful life (RUL) prediction data, and electricity price data. The EV charging demand data may be subdivided into: (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory-recurrent neural network (LSTM-RNN) deep learning (DL) technique to forecast how many cars may attempt to charge in the upcoming time-window, and how much power may be demanded by them. Each agent in the deep reinforcement learning (DRL) platform may be configured to apply a combination of deep learning (DL) and reinforcement learning (RL) machine learning (ML) techniques. Each agent may be trained to make decisions by continuously interacting with an environment. Each agent may start with a random policy and may receive either positive or negative feedback for every action taken by the agent. Each agent may be configured to maximize positive feedback and to minimize negative feedback.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a DRL-EMS process coupled to a distributed computing network according to one or more example implementations of the disclosure;

FIG. 2 is an example of a distributed energy system according to one or more example implementations of the disclosure;

FIG. 3 is an example flowchart of the DRL-EMS process of FIG. 1 according to one or more example implementations of the disclosure;

FIG. 4 is an example of a DRL based energy management system (EMS) according to one or more example implementations of the disclosure;

FIG. 5-6 are examples of deep reinforcement learning (DRL) models according to one or more example implementations of the disclosure;

FIG. 7 is a table showing the results of a DRL model according to one or more example implementations of the disclosure;

FIGS. 8-12 are example diagrammatic views of the DRL-EMS process of FIG. 1 according to one or more example implementations of the disclosure;

FIGS. 13-14 are example demand forecasts used in the DRL-EMS process of FIG. 1 according to one or more example implementations of the disclosure;

FIGS. 15-16 are example forecast training models used in the DRL-EMS process of FIG. 1 according to one or more example implementations of the disclosure;

FIGS. 17-19 show example use-case scenarios of DRL-EMS process of FIG. 1 according to one or more example implementations of the disclosure; and

FIGS. 20-24 show example use-case scenarios of a battery charge-discharge decision-making model.

Like reference symbols in the various drawings indicate like elements.

### DETAILED DESCRIPTION

### System Overview

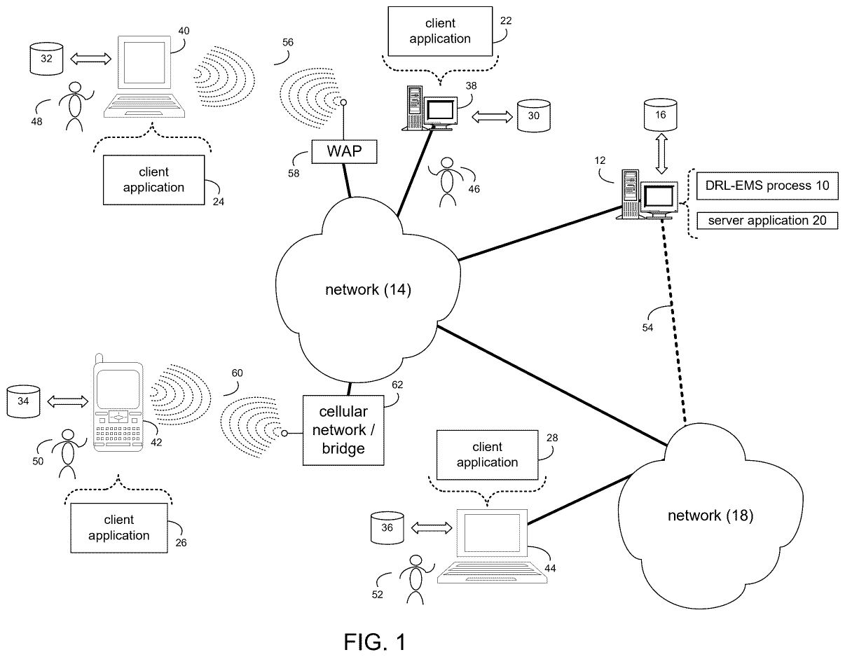

Referring to FIG. 1, there is shown DRL-EMS process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally and/or alternatively, the routing topology process may reside on a client electronic device, such as a personal computer, notebook computer, personal digital assistant, or the like.

The instruction sets and subroutines of the DRL-EMS process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute DRL-EMS process 10. Examples of client applications 22, 24, 26, 28 may include, but are not limited to, EDAs or design verification tools such as those available from the assignee of the present disclosure. These applications may also be executed by server computer 12. In some embodiments, DRL-EMS process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, DRL-EMS process 10 may be a client-side application residing on one or more client electronic devices 38, 40, 42, 44 (e.g., stored on storage devices 30, 32, 34, 36, respectively). As such, DRL-EMS process 10 may be a stand-alone application that interfaces with a client application (e.g., client applications 22, 24, 26, 28), or may be applets/applications that may be executed within a client application. As such, DRL-EMS process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, DRL-EMS process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

### The Distributed Energy System

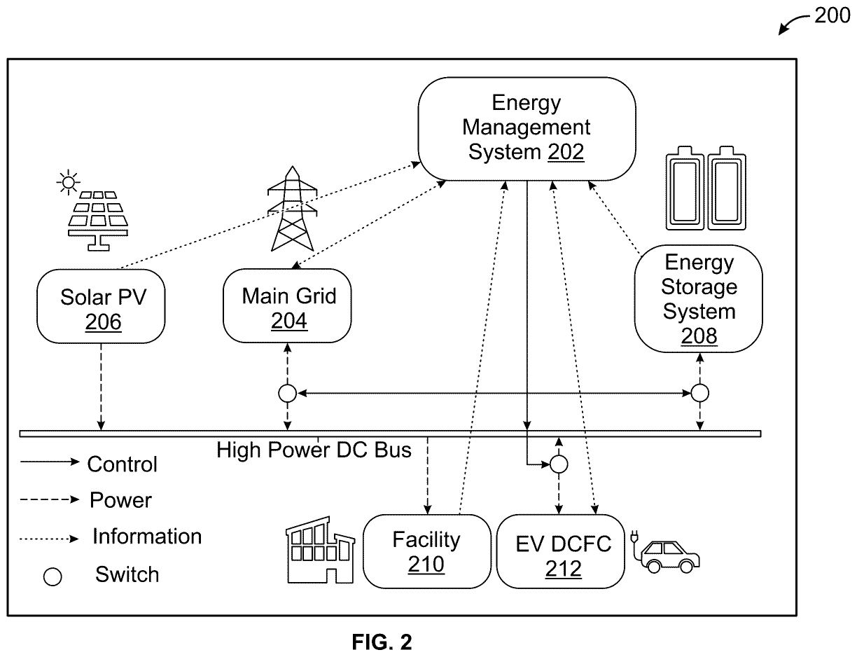

Referring also to FIG. 2, a distributed energy system (e.g. microgrid 200) may include an energy management system (e.g. EMS 202), a small-scale power grid that may operate independently from a primary power grid (e.g. grid 204), and provide a reliable and resilient source of power for communities, institutions, and industrial complexes. Typically small-scale power grids like microgrid 200 may include several key components like power generators (e.g. solar PV 206), energy storage systems (e.g. ESS 208), and power distribution infrastructure (shown by blue arrows in FIG. 2). Power generators may include renewable energy sources such as solar photovoltaics (PV) or wind turbines, as well as conventional fossil fuel-based generators. Energy storage systems, like ESS 208, may be used to store excess energy generated by power generators, like solar PV 206, for later use in order to help ensure a steady and uninterrupted power supply. Power distribution infrastructure may then distribute the generated power to various loads, which may include homes, businesses, and other buildings (e.g. facility 210).

Microgrid 200 may operate in two modes: (i) grid-connected mode and (ii) islanded mode. In grid-connected mode, microgrid 200 may be connected to main grid 204 and draw power from grid 204 when needed. In islanded mode, microgrid 200 may operate independently from grid 204 and rely on its own power generation and storage. Islanded mode may be particularly useful during power outages or other disruptions in main grid 204, by ensuring that microgrid 200 may continue to provide a reliable source of power.

In some implementations, microgrid 200 may also include several additional components that may be integrated to provide greater redundancy and reliable alternative sources of power. These sources may include things like a DC fast charging system for electric vehicles (EVs) (e.g. EV DCFC 212), battery energy storage systems, and renewable energy resources like solar PV 206. Together, these components may work in unison to provide a sustainable and efficient source of power for the community, while also reducing carbon emissions and promoting clean energy.

### The Deep Reinforcement Learning Energy Management Process

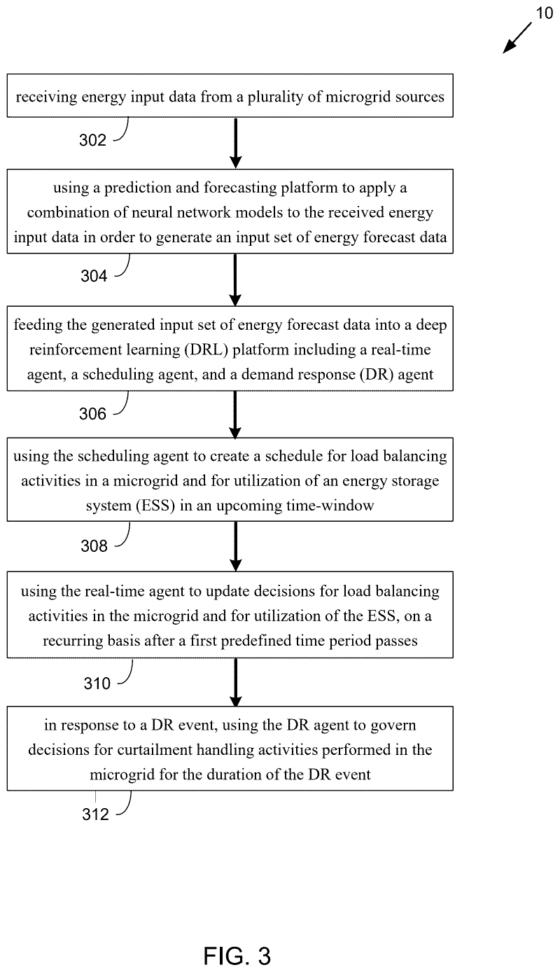

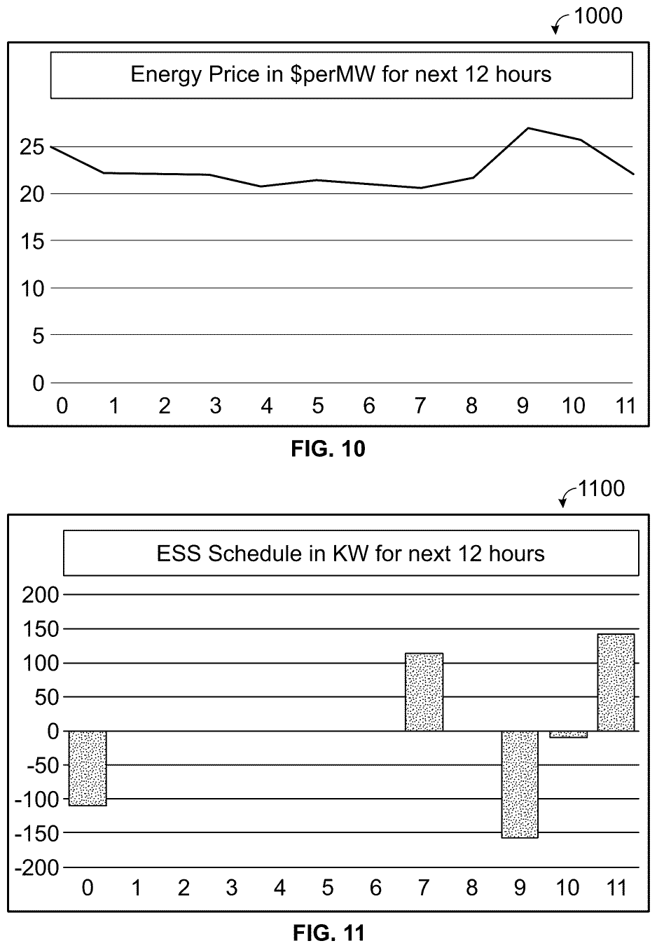

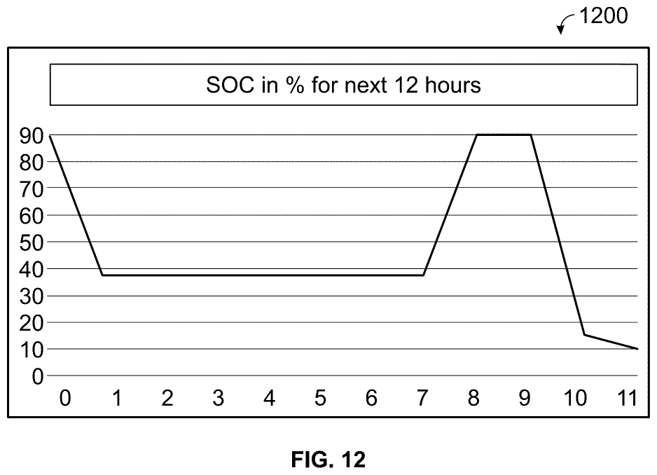

Referring also to FIGS. 3-12 in some implementations, DRL-EMS process 10 may receive (302) energy input data from a plurality of microgrid sources and then use (304) a prediction and forecasting platform to apply a combination of neural network models to the received energy input data in order to generate an input set of energy forecast data. DRL-EMS process 10 may also feed (306) the generated input set of energy forecast data into a deep reinforcement learning (DRL) platform including a real-time agent, a scheduling agent, and a demand response (DR) agent, and then use (308) the scheduling agent to create a schedule for load balancing activities in a microgrid and for utilization of an energy storage system (ESS) in an upcoming time window. DRL-EMS process 10 may go on to use (310) the real-time agent to update decisions for load balancing activities in the microgrid and for utilization of the ESS, on a recurring basis after a first predefined time period passes. Further, in response to a DR event, DRL-EMS process 10 may use (312) the DR agent to govern decisions for curtailment handling activities performed in the microgrid for the duration of the DR event.

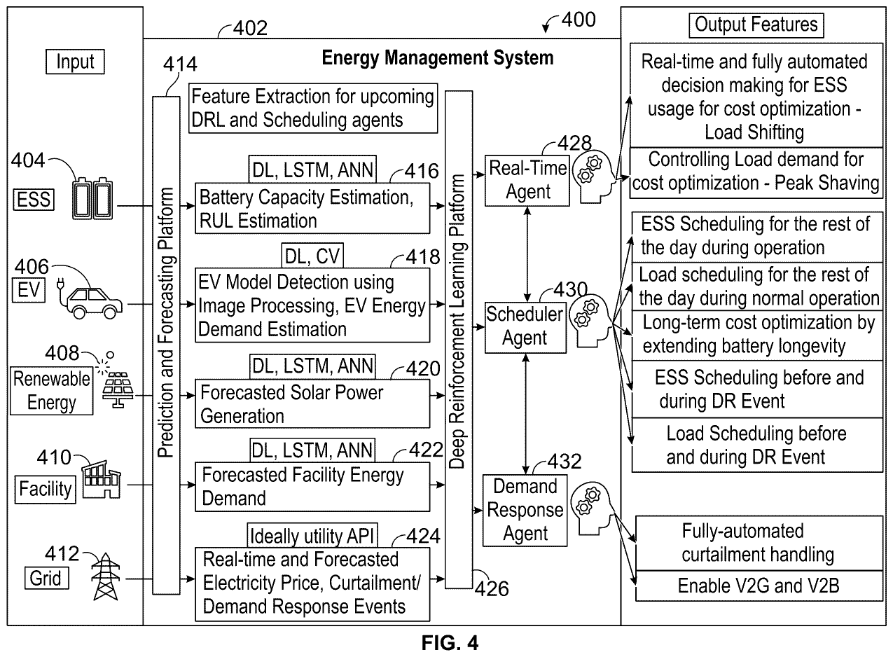

In some implementations, DRL-EMS process 10 may receive (302) energy input data from a plurality of microgrid sources and then use (304) a prediction and forecasting platform to apply a combination of neural network models to the received energy input data in order to generate an input set of energy forecast data. Consider example 400, shown in FIG. 4, where an energy management system (e.g. EMS 402) may receive input data from a plurality of microgrid sources including a battery energy storage system (e.g. BESS 404), a plurality of electric-vehicle (EV) charging stations (e.g. EV 406), a plurality of solar photovoltaic (PV) panels (e.g. solar PV 408), one or more facility buildings (e.g. facility 410), and a connection to a primary power grid (e.g. grid 412). More specifically, EMS 402 may include a prediction and forecasting platform (e.g. PF platform 414) configured to receive the input data from this plurality of microgrid sources. PF platform 414 may also be configured to generate an input set of energy forecast data including ESS remaining useful life (RUL) prediction data (e.g. ESS data 416), EV charging demand data (e.g. EV data 418), solar PV power generation forecast data (e.g. solar data 420), facility usage forecast data (facility data 422), and electricity price data (e.g. grid data 424). Further, PF platform 414 may then feed elements from the input set of energy forecast data to a deep reinforcement learning (DRL) platform (e.g. DRL platform 426). In some implementations, PF platform 414 may also include one or more agents configured to use machine learning (ML) models to generate the forecast data that may be fed into DRL platform 426.

In some implementations, ESS data 416 may be further subdivided into (i) ESS capacity degradation estimation data and (ii) ESS RUL prediction data. ESS capacity degradation estimation data may be generated by applying an artificial neural network (ANN) deep learning technique to select battery attributes such as capacity, voltage, current, and temperature for each usage cycle. ANNs may be a class of algorithms inspired by the structure and functioning of biological neural networks found in the human brain, and they may be used for a wide range of tasks, including classification, regression, clustering, and more. The ANN deep learning technique may be used to estimate the battery capacity degradation for each cycle. ESS RUL prediction data may be obtained by applying a deep learning long short-term memory (DL LSTM) forecasting technique to historical battery discharge data and the degradation trend of the ESS. In this context, degradation trend may refer to the charging or discharging of the ESS at very high current and extreme temperatures that may increase the rate of cycle aging, i.e. aging that happens in the battery while cycling.

In some implementations, the DRL-EMS algorithm may consider the degradation of the battery life and the trend or rate of degradation to fine-tune the usage of the ESS. For example, the scheduling agent may avoid charging the ESS to full or very high SOC unless there is an imminent demand requiring the use of that stored energy, or if the energy price may be so low that drawing power from the grid may be a better financial decision.

Similarly, for cycle aging consideration, the DRL-EMS optimization considers the cost of using the ESS, and follows constraints that essentially ensures that degradation of ESS health is as low as possible; such as maintaining the charging and discharging currents within certain limits.

In some implementations, EV data 418 may be further subdivided into: (i) real-time power demand data, (ii) estimated EV charging demand data for each charging session, and (iii) forecasted EV charging demand data for the upcoming day. Real-time power demand may be obtained when an EV requests power from a charging station. The charging station may relay this request to the EMS, which in turn may use this information to make real-time decisions about energy usage and storage. Estimated EV charging demand data for each charging session may be generated by applying a deep learning technique to a combination of factors that include but are not limited to the EV make and model, the EV charging curve, the current location, time of the day, season, and weather. The deep learning technique may be used to estimate how many kilowatt-hours of energy may be demanded by the EV through the charging station/microgrid during the charging session. Forecasted EV charging demand data for the upcoming day may be generated by applying forecasting techniques such as a deep learning a long short-term memory-recurrent neural network (LSTM-RNN) to forecast how many cars may try to charge in the upcoming 24 hours, and how much power may be demanded by them. LSTMs may be a type of recurrent neural network (RNN) architecture designed to model sequences and long-term dependencies in data. RNNs may be a type of artificial neural network designed for processing sequential data, such as time series, text, speech, or video data. Unlike traditional feedforward neural networks, RNNs may have loops in their architecture, allowing them to maintain a “memory” of previous inputs in a sequence. As such, LSTMs may be particularly effective at handling tasks where previous information in a sequence significantly influences predictions or outputs, and may be used to help schedule the ESS usage in a microgrid more accurately.

In some implementations, solar data 420 may be further subdivided into (i) real-time solar PV power generated data, and (ii) forecasted solar PV power generation data. Real-time solar PV power generated data may be obtained by reading data from one or more inverters connected to solar PV 408. These inverters may provide real-time data on the solar power generated by solar PV 408, and this real-time data may be used by EMS 402 to make real-time decisions about energy usage and storage. Forecasted solar PV power generation data may be generated by applying deep learning forecasting techniques such as LSTM-RNN to historical solar power generation data. The LSTM-RNN forecasting technique may take into account a combination of factors including but not limited to the weather forecast, season, and current location to predict future solar power generation patterns.

In some implementations, facility data 422 may be further subdivided into (i) real-time power demand data, and (ii) forecasted facility power demand data. Real-time power demand data may be obtained by reading data from one or more smart meters that may be installed in facility 410. The smart meters may be connected to EMS 402 and provide real-time data on the energy usage of facility 410. Real-time power demand data may be used by EMS 402 to make real-time decisions about energy usage and storage. Forecasted facility power demand data may be generated by applying deep learning-based forecasting techniques such as LSTM-RNN to historical facility energy usage data. The LSTM-RNN forecasting technique may use the historical data to predict future energy usage patterns, which may enable EMS 402 to schedule energy storage system (ESS) usage and achieve high-cost optimization.

In some implementations, grid data 424 may be further subdivided into (i) real-time electricity price data, (ii) upcoming electricity price forecast data, and (iii) demand response event data. Real-time electricity price data may be collected every 5 minutes from grid 412 via an application programming interface (API) to provide real-time data on the current price of electricity. Upcoming electricity price forecast data may be collected from grid 412 via an API every day at a specific time of the day for the next day's expected electricity price. In the case that upcoming electricity price forecast data is not available via API, EMS 402 may alternatively generate this forecast data by applying forecasting techniques such as LSTM-RNN to historical electricity price data. EMS 402 may also account for demand response (DR) events, which may be organized by utility companies and grid operators. During DR events, microgrids may be asked to go into an islanded mode and to reduce their energy consumption. DR events may provide financial and economic benefits and further cost optimization for the microgrid. Accordingly, DR event signals may be received via APIs or through an open automated demand response (OpenADR) protocol. OpenADR protocol may be a standardized communication framework used to automate and streamline demand response processes in energy management like EMS 402. OpenADR may allow energy providers, utilities, and grid operators to send signals to energy consumers, enabling automated adjustments of electricity usage in response to grid conditions, such as peak demand periods or system stress.

In some implementations, DRL-EMS process 10 may feed (306) the generated input set of energy forecast data into a deep reinforcement learning (DRL) platform (e.g. DRL platform 426) including a real-time agent (e.g. real-time agent 428), a scheduling agent (e.g. schedule agent 430), and a demand response (DR) agent (e.g. DR agent 432). Deep reinforcement learning (DRL) may be a subfield of machine learning (ML) that combines the principles of reinforcement learning with deep learning techniques. Reinforcement learning (RL) may be a type of learning where an agent learns to make decisions by receiving rewards or penalties for certain actions. In DRL models, an agent may use deep neural networks, which may be complex multi-layered neural networks, to process and analyze large amounts of data. The DRL agent may be trained to make decisions by continuously interacting with whatever environment it happens to be placed in. Typically, DRL agents like real-time agent 428, scheduling agent 430, and DR agent 432 may start with a random policy and use trial and error to learn the best actions to take in different situations.

In some implementations, DRL-EMS process 10 may also use (308) the scheduling agent to create a schedule for load balancing activities in a microgrid and for utilization of an energy storage system (ESS) in an upcoming time window, and use (310) the real-time agent to update decisions for load balancing activities in the microgrid and for utilization of the ESS, on a recurring basis after a first predefined time period passes. Load balancing activities may refer to the process of distributing electricity demand evenly across available power generation resources and distribution infrastructure. In the context of EMS 402, may involve things like limiting the number of EV charging stations in use during certain hours of the day, limiting the use of air-conditioning inside the facility, or only charging the ESS during off-peak hours. Such activities may ensure optimal utilization of resources, reduce stress on the grid, and maintain reliable and efficient energy delivery to consumers.

In some implementations, in response to a DR event, DRL-EMS process 10 may use (312) the DR agent to govern decisions for curtailment handling activities performed in the microgrid for the duration of the DR event. A DR event may refer to a specific time period during which electricity consumers may be asked to adjust their power usage in response to signals from grid operators or utility companies. DR events may typically be initiated during high-demand periods, such as hot summer afternoons when air conditioning usage is high, or during unforeseen grid constraints (e.g., equipment failure). The primary objective of DR events may be to reduce or shift electricity demand to maintain grid stability, lower energy costs, or avoid blackouts during peak usage or emergencies. Curtailment handling activities may refer to the strategies and processes used to manage situations where energy generation exceeds demand or may not be fully utilized due to limitations in the grid or other system constraints. Such activities may primarily apply to renewable energy sources like wind and solar, which may produce variable amounts of energy based on weather conditions.

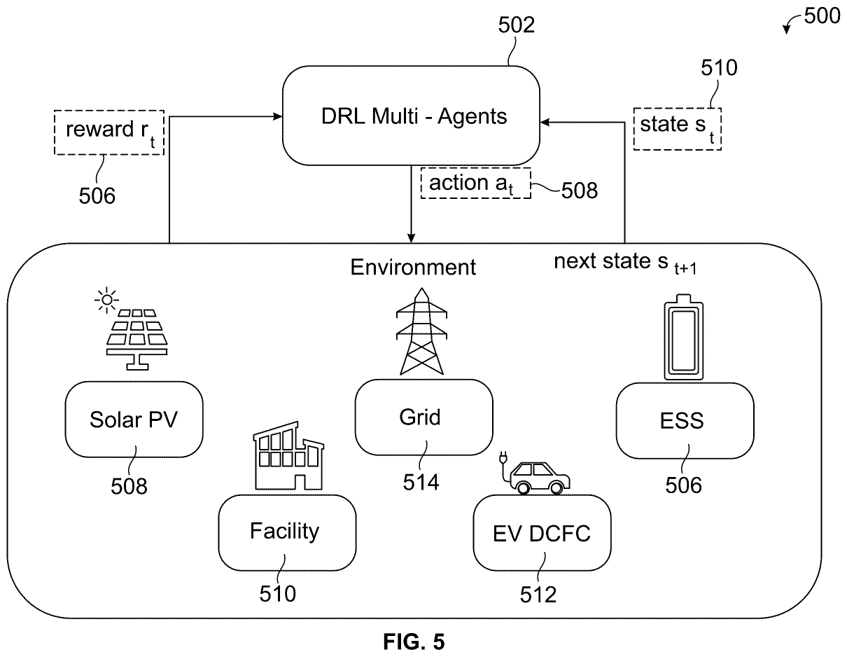

Consider for example, DRL model 500 shown in FIG. 5. DRL model 500 may include a plurality of DRL agents (e.g. DRL agents 502) that may be placed in an environment (e.g. environment 504). In the context of EMS 402, environment 504 may include the same physical components previously discussed in microgrid 200 shown in FIG. 2. Namely, environment 504 may include a battery energy storage system (e.g. ESS 506), a power generator (e.g. solar PV 508), one or more buildings (e.g. facility 510), one or more EV charging stations (e.g. EV DCFC 512), and a connection to a main power grid (e.g. grid 514). In DRL model 500 DRL agents 502 may exist and interact with the physical components of environment 504. More specifically, DRL agents 502 may receive positive or negative feedback in the form of rewards or penalties (e.g. reward 506) based on the actions (e.g. action 508) taken in relation to the physical components of environment 504. In effect, every action 508 performed by DRL agent 502 may generate some form of feedback from environment 504 like reward 506, and this feedback may then affect the state/condition (e.g. state 510) of environment 504. DRL agent 502 may be initialized by a random policy (e.g. policy 512) that may provide instructions for DRL agent 502 to map state 510 to action 508 to begin with. DRL agent 502 may also be configured to recognize the value or future reward, that may be offered in response to action 508. In this way, DRL model 500 may encourage DRL agent 502 to learn over time how to maximize rewards by taking actions that lead to the best possible rewards.

Referring again to FIG. 4, in the context of EMS 402, a DRL-based approach may be used to create an optimal and fully automated energy management system for microgrids. With the right combination of policies and rewards, over time EMS 402 may learn how to monitor, control, and optimize energy usage within a microgrid, with the aim of reducing energy consumption and costs while maintaining high energy efficiency. To accomplish this goal, EMS 402 may use three separate agents, namely real-time agent 428, schedule agent 430, and DR agent 432. Real-time agent 428 may be responsible for dealing with normal operations over the course of the day. For example, real-time agent 428 may determine how much power should be drawn from the main power grid during the day, and how much power should be spent charging the ESS or used in discharging the ESS. Further real-time agent 428 may also govern peak-shaving activities, which may refer to the practice of reducing electricity consumption during periods of peak demand. Because EV demand may be difficult to predict with very high accuracy, the primary value of real-time agent 428 may lay in handling the unpredictability created by the difference between the forecasted demand and the actual demand. Moreover, real-time agent 428 may adapt to the difference in real-time.

Schedule agent 430 may be responsible for scheduling the charge and discharge cycles for an energy storage system (ESS) and for balancing the electrical load. More specifically, schedule agent 430 may schedule the ESS usage and load allocation for the day both during normal operations and for the upcoming day and before any scheduled DR events. Scheduling agent 430 may essentially create a plan (schedule) for a day, which may give EMS 402 an estimation of how much cost savings may be possible on that day. Of course, the real demand and generation may be different from the forecasted demand and generation, which may cause a change in the final cost savings.

In some implementations, schedule agent 430 may make use of Model Predictive Control (MPC), taking inputs from PF platform 414 as well as the other two agents in DRL platform 426. MPC may be a control strategy that may use an explicit dynamic model of a system to predict and optimize future behavior of the system. In the context of machine learning and control theory, MPC is often used to solve decision-making problems where it is necessary to control a system to achieve a desired outcome while respecting constraints. DR agent 432 may be responsible for making decisions during demand response and critical mission events, such as outages. For example, DR agent 432 may perform real-time cost optimized decision making about grid usage, and ESS usage both before and during a DR event. DR agent 432 may also make decisions about scheduled ESS usage and scheduled load allocation during a DR event.

EMS 402 may be considered to be similar to a DRL-based-MPC. Some implementations may employ an energy management solution that may be considered MPC-with-Optimization, where the Optimization technique may use mixed integer linear programming (MILP). This MILP based solution may also work well, but it may be a deterministic approach where the DRL based solution may be a Stochastic approach. The DRL based approach used by EMS 402 may have more long-term benefits such as, learning from experience in a way that may lead to continuous improvement with more data, learning optimal strategies even under uncertain forecasts. Additionally, DRL based approach used by EMS 402 may more effectively adapt to dynamic environments, for example EMS 402 may be better able to handle unseen scenarios, and non-linear dynamics, where the deterministic approach may fail to converge for given system constraints for unexpected demand and generation.

In practice, schedule agent 430 may be the first to act by creating a schedule for the upcoming day (24-hour schedule). Then real-time agent 428 may act throughout the course of the day by updating on regular intervals (e.g. every 2 mins) or on certain predefined event triggers. Real-time agent 428 may also update the schedule generated by schedule agent 430. DR agent 432 may only come into play when a DR event occurs. If a DR event occurs then DR agent 432 may create a new schedule for the charge and discharge cycles for an energy storage system (ESS) and for balancing the electrical load across the microgrid. Additionally, for the duration of the DR event, DR agent 432 may override any schedules generated by the other two agents.

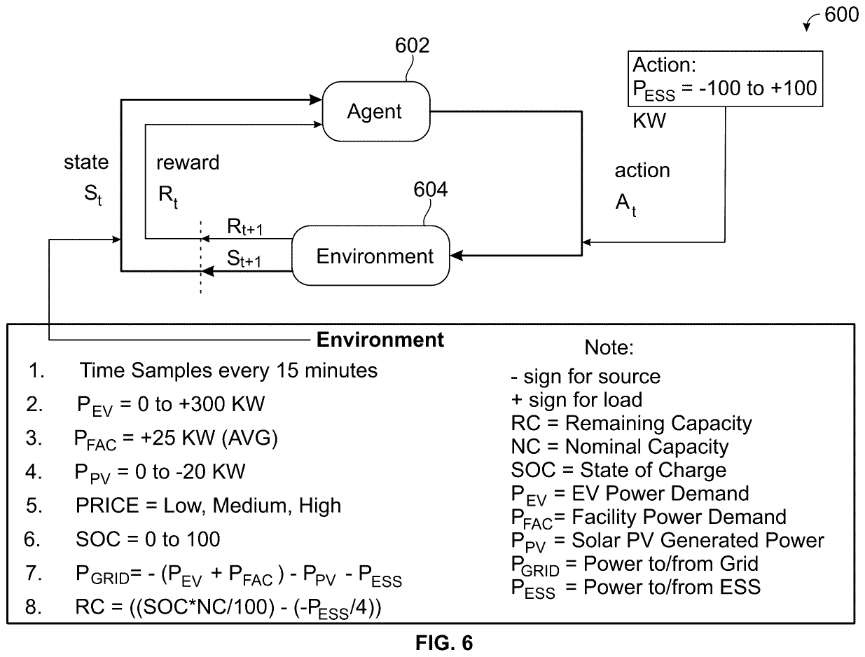

Consider, for example, DRL model 600 shown in FIG. 6. DRL model 600 may be set up as a Markov decision process (MDP), where one or more DRL agents (e.g. DRL agents 602) may interact with an environment (e.g. environment 604), state, reward, and action may be based on EMS 402. An MDP may be a mathematical framework used for modeling decision-making in scenarios where outcomes may be partly random and partly under the control of a decision-maker, like DRL agents 602. Additionally, DRL agents 602 may employ deep reinforcement learning algorithms such as advantage actor-critic (A2C), and proximal policy optimization (PPO), where A2C may be designed to optimize policy and value functions simultaneously, and may be used to train agents in environments with sequential decision-making tasks, and PPO may be a policy-gradient-based algorithm designed to improve training stability and efficiency for reinforcement learning agents.

Consider the following feedback conditions as an example. DRL agents 602 may receive negative feedback for charging ESS when the price of electricity may be higher than normal and may receive positive feedback for charging ESS when the price of electricity may be lower than normal. DRL agents 602 may receive negative feedback for discharging ESS when the price of electricity may be lower than normal, and receive positive feedback for discharging ESS when the price of electricity may be higher than normal. DRL agents 602 may receive negative feedback for charging ESS when the state of charge (SOC) may be higher than normal and may receive positive feedback for charging ESS when the SOC may be lower than normal. DRL agents 602 may receive negative feedback for discharging ESS when the SOC may be lower than normal and may receive positive feedback for discharging ESS when the SOC may be higher than normal. DRL agents 602 may be considered to have failed if the SOC of the ESS falls too low, or gets too close to 0%. Further, DRL agents 602 may consider the total overall cost in terms of negative feedback, i.e. the higher the total overall cost, the more the negative reward.

Now further consider the following environmental factors in the context of DRL model 600. The EV charging demand may depend on how many charging stations may be available and how many cars may be ready to be charged. In the context of DRL model 600, EV demand may go up to a maximum of 600 KW, and EV demand may be monitored in real-time and forecasted for up to 24 hours. The facility power demand may depend on season, temperature, day, etc., and may be forecasted for up to 24 hours. The electricity price may depend on utility, day, season, temperature, etc., and may be forecasted for up to 24 hours. The solar PV power generation may depend on the weather, season, etc., and may be forecasted for up to 24 hours. The energy storage system state of charge (ESS SOC) may range from 0-100%. Power from the grid may be calculated based on the environment and actions from the agents. The remaining ESS capacity may be calculated using ESS SOC and actions from DRL agents 602.

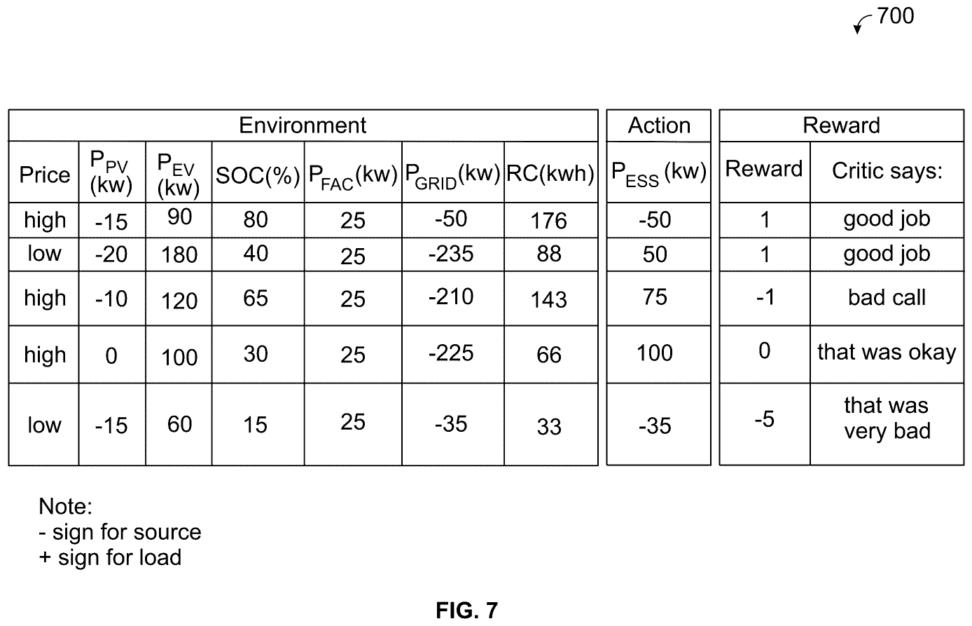

Based on the feedback conditions and environmental conditions discussed above in regard to DRL model 600, table 700 shown in FIG. 7 may illustrate what actions DRL agents 602 choose to take based on the state of the environment, and how what kind of feedback was received in response to those actions. For example, in response to discharging 50 kW when the state of charge was at 80%, the remaining capacity was at 176 kWh, and the price of electricity was high, RDL agent 602 received positive feedback in the form of 1 reward point.

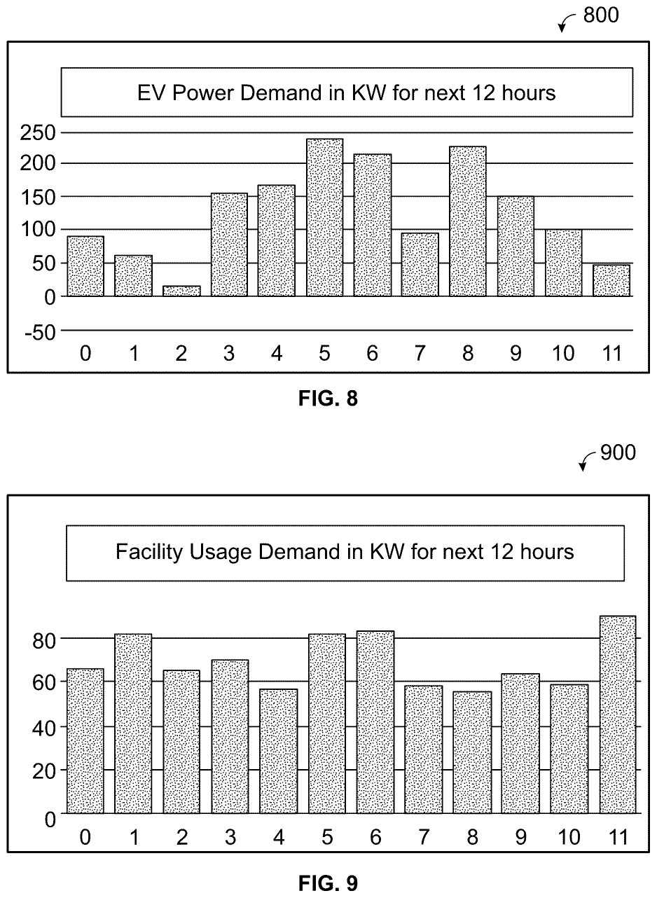

Referring now to FIGS. 8-12, EV power demand forecast 800, facility usage demand forecast 900, electricity price demand forecast 1000, ESS projected schedule 1100, and projected state of charge 1200 are provided according to one or more example implementations of the disclosure. The examples may show where schedule agent 430, may determine the ESS usage schedule over the next 12 Hours, and how schedule agent 430 may use 12 hours of forecasted EV power demand, 12 hours of forecasted Facility power usage demand, and day-ahead electricity price to calculate and schedule ESS usage.

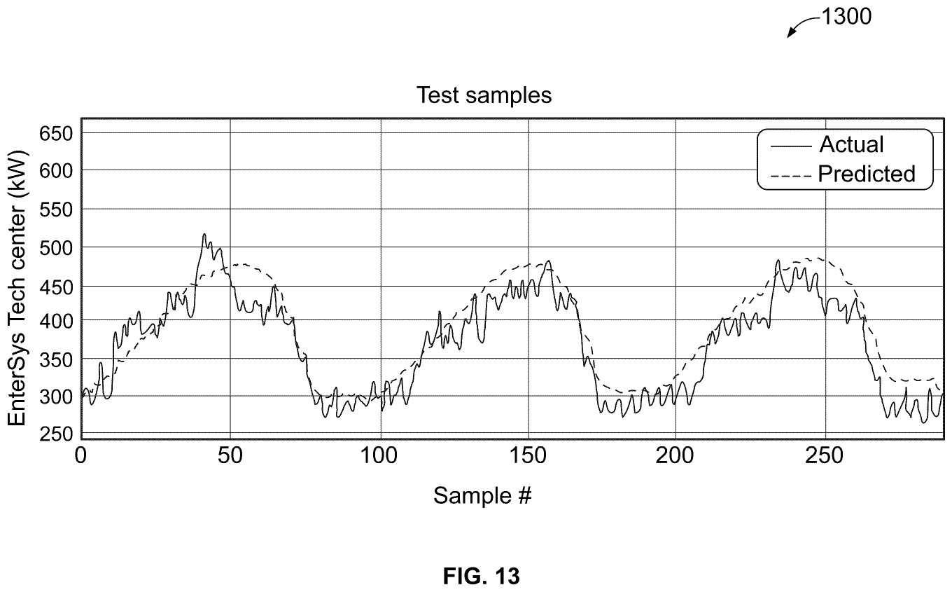

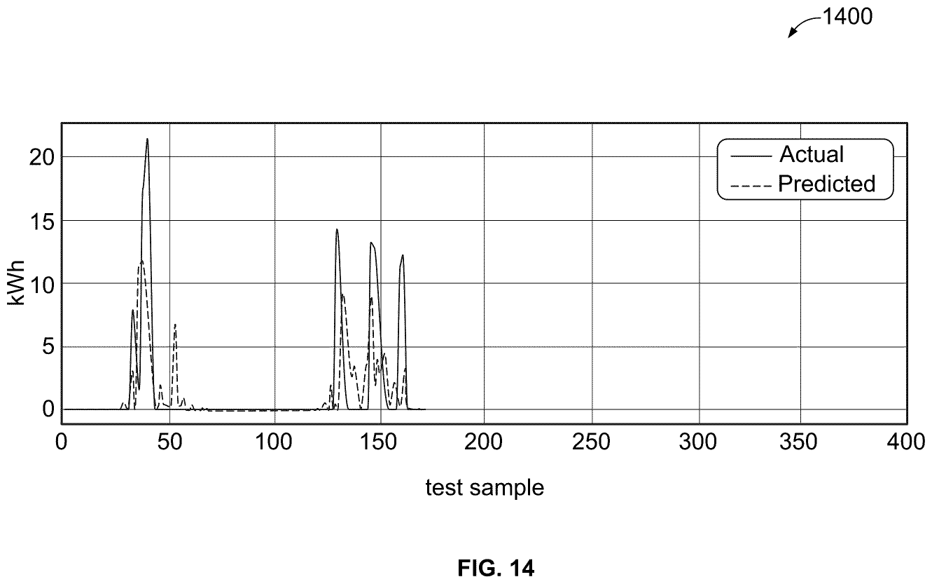

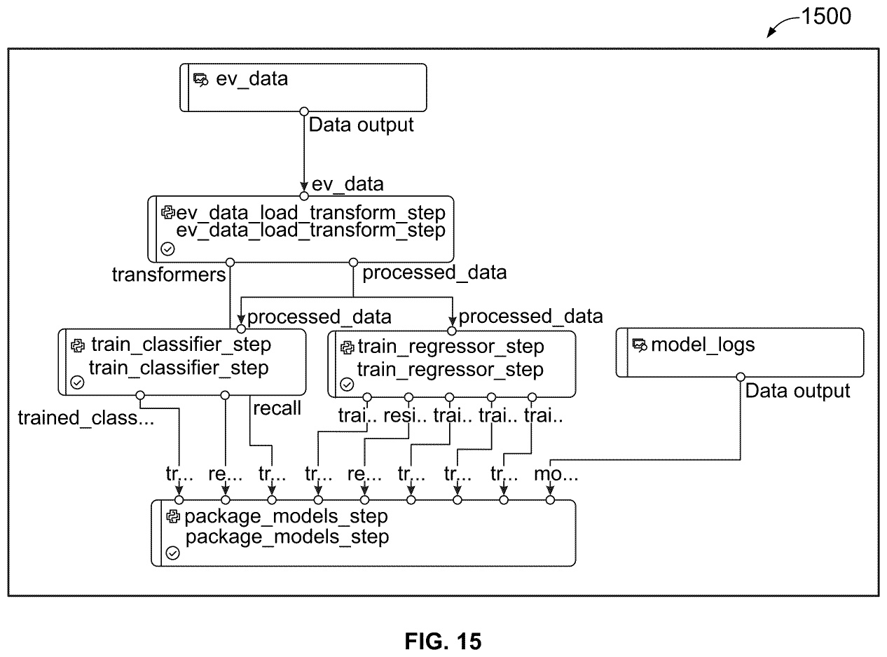

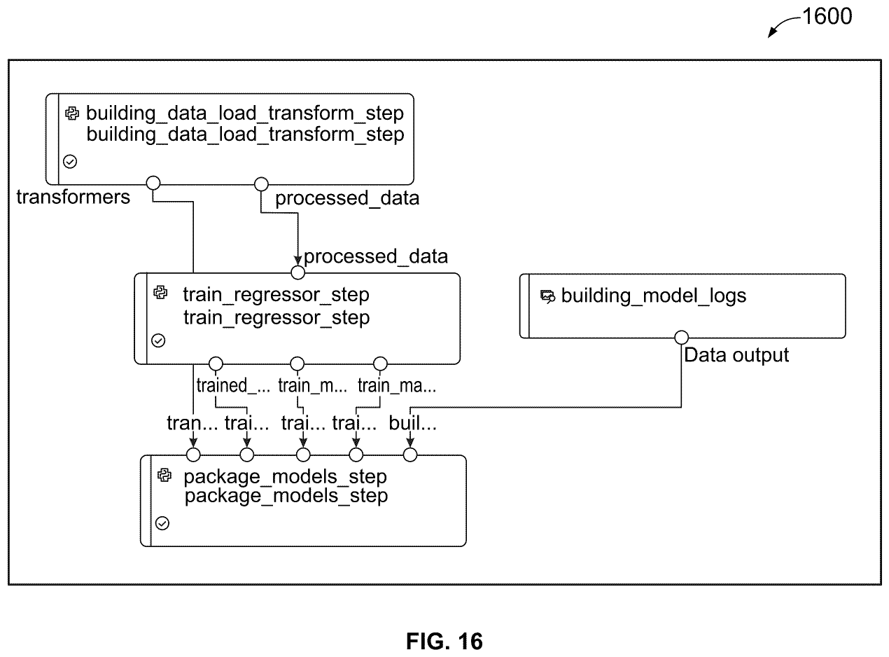

Referring now to FIGS. 13-16, example demand forecasts 1300, 1400, and example forecast training models 1500, 1600 used in the DRL-EMS process 10 are provided according to one or more example implementations of the disclosure. Demand forecast 1300 may compare actual demand to the predicted forecast generated by a deep learning model trained on historical building demand data. Similarly, demand forecast 1400 may compare actual demand to the predicted forecast generated by a deep learning model trained on historical EV demand data. Forecast training model 1500 may show an example of a training pipeline for forecasting building demand, corresponding to demand forecast 1300. Similarly, forecast training model 1600 may show an example of a training pipeline for forecasting EV demand, corresponding to EV forecast 1400.

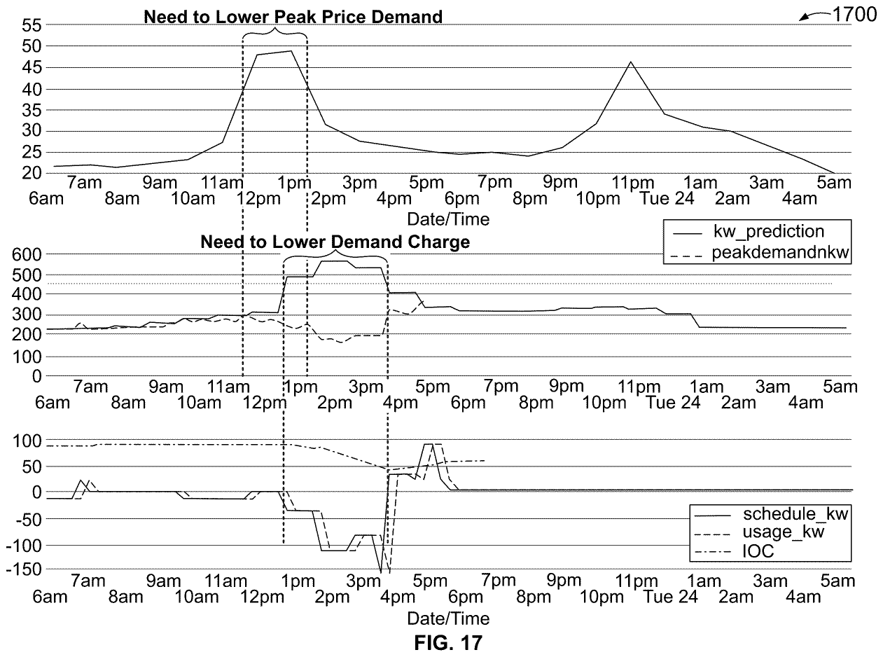

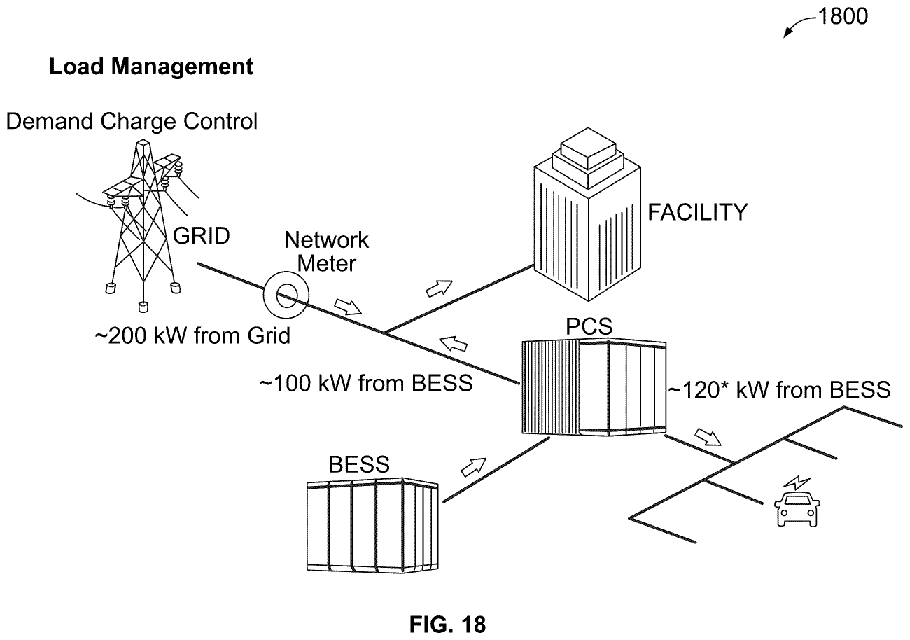

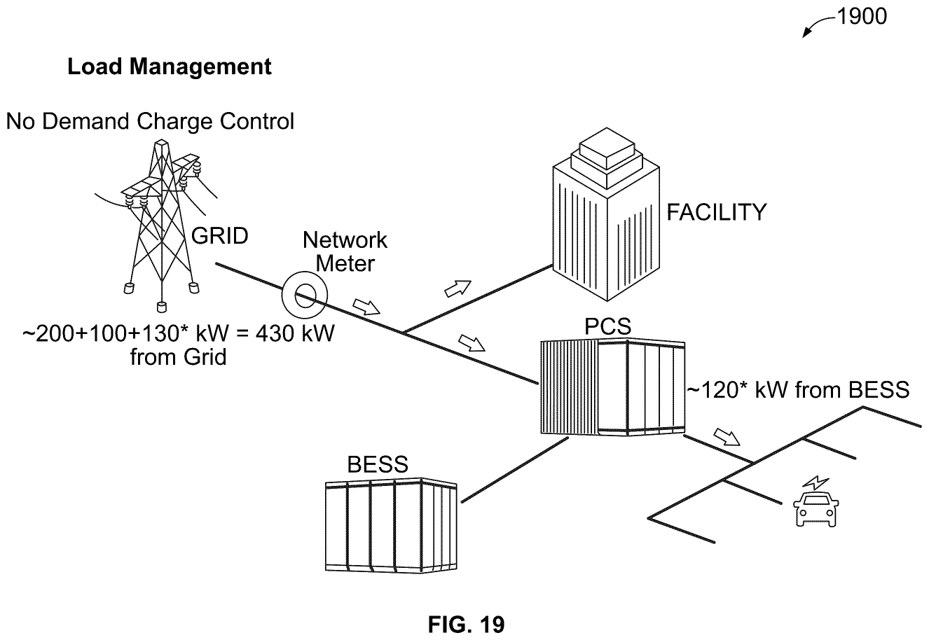

Referring now to FIGS. 17-19, energy usage graph 1700, and visual representations 1800, 1900 are provided according to one or more example implementations of the disclosure. Consider energy usage graph 1700 for a real-world use-case of the performance of the DRL agents. In this example, usage graph 1700 may show a spike in pricing between 11 am and 2 pm, and how DRL agents may recognize this change and make a decision to shift away from drawing power from the energy grid and instead draw power from alternate energy sources like a battery energy storage system (BESS). Visual representation 1800 may show how the demand charge and peak power was reduced, such that only 200 kW was drawn from grid and the rest of the energy demand was provided by the BESS. In contrast, visual representation 1900 may show what would happen if there was no DRL-EMS. In this scenario, the peak power of 430 kW may not have been avoided and as a result the entire demand may have been drawn from the grid, resulting in a high demand charge and energy cost.

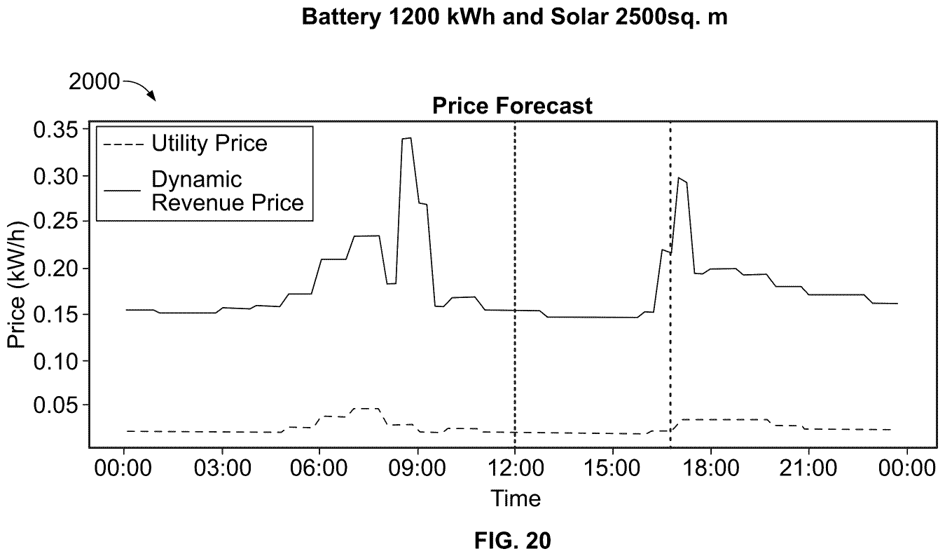

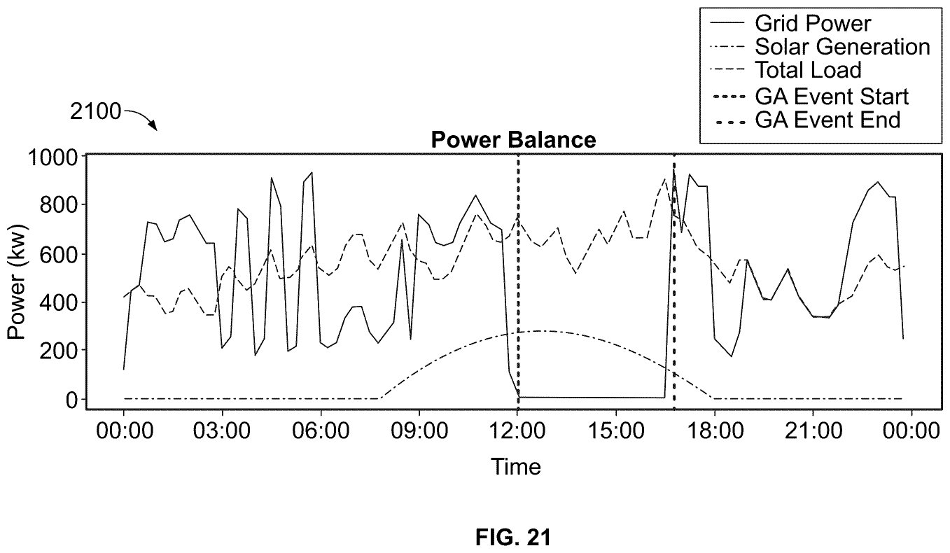

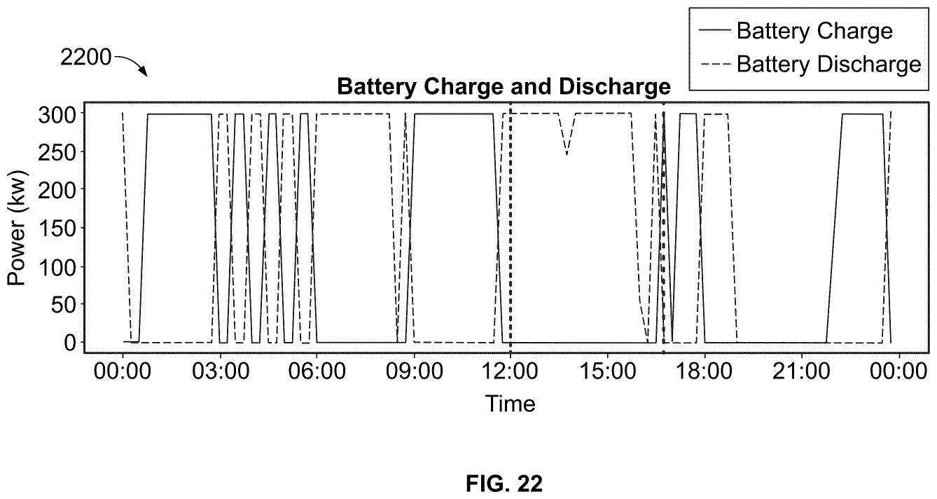

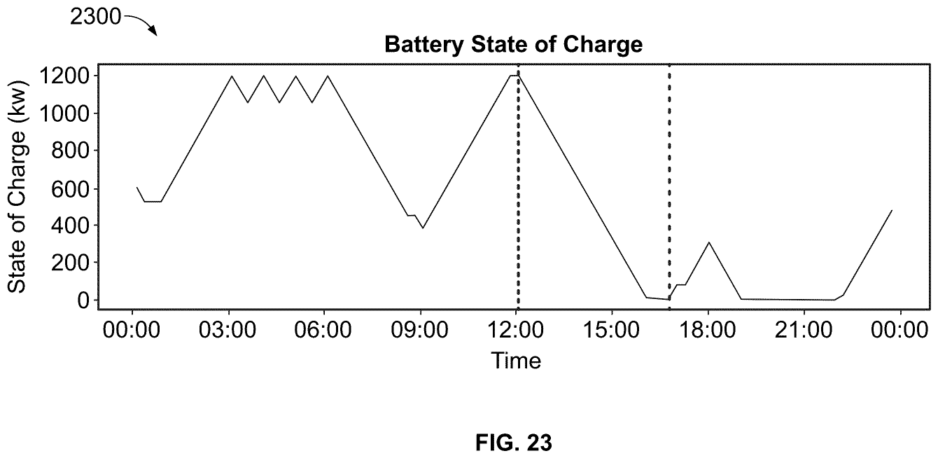

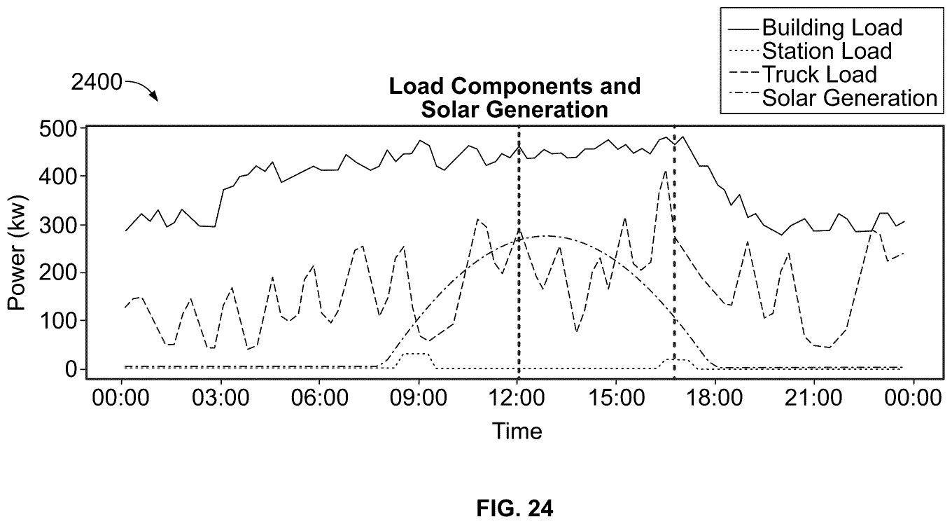

Referring now to FIGS. 20-24, example use-case scenarios 2000, 2100, 2200, 2300, 2400 of DR agent discharging schedule is provided according to one or more example implementations of the disclosure. In these scenarios, a demand response (DR) event may be underway having 100% grid usage reduction and a curtailment capacity of 3442.09 kW during curtailment, where the curtailment hours may range from 12 pm to 5 pm (highlighted by the vertical lines). The DR-Agent may generate the battery charging/discharging schedule, thereby ensuring 100% grid usage reduction during curtailment hours. Grid usage may also be seen in the power balance subplot. During DR events, energy suppliers may charge an expensive energy rate (DR rate) to cover the cost of maintaining and expanding electricity infrastructure, funding conservation programs, and ensuring a reliable supply. The DR rate may move inversely with the hourly energy price (HEP), such that when the HEP is low the DR rate may be higher, and vice versa.

In some implementations, DRL-EMS process 10 may provide fully automated and cost-optimized ESS scheduling to enable efficient peak-shaving and load shifting of the microgrid, and also handle DR events and curtailment activities effectively. Further, DRL-EMS process 10 may not be heavily dependent on historical data, because deep reinforcement learning (DRL) may not require any historical data for training.

In some implementations, DRL-EMS process 10 may make use of eight machine-learning models for different purposes. Two neural network (NN) models may be used for facility energy usage forecasts. The first long short-term memory (LSTM) model may be used to solve a multivariate forecasting problem and to forecast the energy usage of the facility. The second artificial neural network (ANN) model may run a forecast at a specific time of the day and based on meter readings of the building and real-time weather reading, re-evaluate the forecast for the rest of the day to have a more accurate prediction. The energy usage forecast may be of high importance as the accuracy and performance of the ESS scheduling may highly depend on it.

In some implementations, three DRL-based MPC agents may be used in DRL-EMS process 10. The first agent (real-time agent 428) may deal with the normal operation of day-to-day tasks where the main goal for this agent may be to meet energy demands, lower the cost of operation, and enhance the useful life of the energy storage system (ESS). Cost optimization may be achieved by peak-shaving the power demand and load-shifting by utilizing the ESS and renewable energy resources at the right time. In some implementations, the second agent (scheduling agent 430) may be responsible for scheduling ESS usage and scheduling load for the day, such that scheduling load effectively provides (EV) power demand management. In some implementations, the third agent (DR agent 342) may deal with curtailment and demand response operations. The main goal of this agent may be to meet the load-shedding demands and to meet the critical-energy-usage demands. Lowering costs may not be the goal in this situation, because costs may already be lowered and revenue may be generated by merely participating in demand response and curtailment activities. For example, in this scenario, charging an EV may not be a high priority, but keeping the heating-cooling system of the facility running may fall under higher priority, which in turn may mean that certain types of power demand receive higher priority during demand response events. As such, DR agent 432 may be used to determine how to manage the demand using ESS and Renewable Energy Resources.

In some implementations, two neural network ML models may be used to perform EV charging demand forecasts. The first of these NN models may be an ANN model used to predict the energy demand for each charging session. The second NN model may be an LSTM model used to predict the forecast of the energy demand for EV charging for the upcoming day based on historical data.

In some implementations, eight deep learning (DL) models may be used in DRL-EMS process 10. Six models may be used for feature engineering from EV demand, facility demand, ESS health, and renewable energy generation. Two DRL models may be the main 2 models being used as control algorithms. DRL-EMS process 10 may be used to estimate EV charging energy demand for each charging session and the forecasted EV charging energy demand for each day to make a better scheduling system. DRL-EMS process 10 may also be used to estimate the ESS capacity degradation and to predict the remaining useful life (RUL) of the ESS to make a better cost optimization model.

In some implementations, DRL-EMS process 10 may be described as an agentic-AI solution, which may refer to an artificial intelligence system capable of autonomously making decisions, performing actions, and solving problems with minimal or no human intervention. The term “agentic” may typically describe an entity (like an AI) that may act as an agent, i.e. it may perceive its environment, make decisions, and take actions toward achieving specific goals, based on its programming or learned behavior.

Each AI model used in DRL-EMS process 10 may essentially be considered an AI-agent with a specific task, where these AI-agents may operate in cohesion, such that multiple AI-agents act in sequence and parallel to obtain the desired result.

DRL-EMS process 10, may also separate DRL agents for normal operation from a dedicated agent for operation in demand response events, where the dedicated agent (DR agent 432) may be configured to take care of energy management before and during demand response events. A dedicated scheduler agent (scheduler agent 430) may schedule ESS and load usage and toggle back and forth between the other two agents. In some implementations, DRL-EMS process 10 may also focus on both grid-connected and islanded modes of the microgrid. More specifically, DRL-EMS process 10 may focus on decision-making for cost-efficient switches between the two modes.

It will be apparent to those skilled in the art that various modifications and variations can be made to DRL-EMS process 10 and/or embodiments of the present disclosure without departing from the spirit or scope of the invention. Thus, it is intended that embodiments of the present disclosure cover the modifications and variations of this invention provided they come within the scope of the appended claims and their equivalents.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
receiving energy input data from a plurality of microgrid sources;
using a prediction and forecasting platform to apply a combination of neural network models to the received energy input data in order to generate an input set of energy forecast data;
feeding the generated input set of energy forecast data into a deep reinforcement learning (DRL) platform including a real-time agent, a scheduling agent, and a demand response (DR) agent;
using the scheduling agent to create a schedule for load balancing activities in a microgrid and for utilization of an energy storage system (ESS) in an upcoming time-window;
using the real-time agent to update decisions for load balancing activities in the microgrid and for utilization of the ESS, on a recurring basis after a first predefined time period passes; and
in response to a DR event, using the DR agent to govern decisions for curtailment handling activities performed in the microgrid for the duration of the DR event.

2. The computer-implemented method of claim 1, wherein the plurality of microgrid sources include the ESS, a plurality of electric-vehicle (EV) charging stations, a plurality of solar photovoltaic (PV) panels, one or more facility buildings, and a connection to a primary power grid.

3. The computer-implemented method of claim 2, wherein the input set of energy forecast data includes EV charging demand data, facility usage forecast data, solar PV power generation forecast data, ESS remaining useful life (RUL) prediction data, and electricity price data.

4. The computer-implemented method of claim 3, wherein the EV charging demand data is subdivided into (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory recurrent neural network (LSTM-RNN) deep learning (DL) technique to forecast how many cars will attempt to charge in the upcoming time-window, and how much power will be demanded by them.

5. The computer-implemented method of claim 3, wherein the facility usage forecast data is subdivided into (i) real-time facility power demand data obtained from one or more smart meters installed in the facility configured to provide real-time data on energy usage of the facility, and (ii) forecasted facility power demand data generated by applying a second LSTM-RNN DL technique to historical facility energy usage data.

6. The computer-implemented method of claim 3, wherein the solar PV power generation forecast data is subdivided into: (i) real-time solar PV power generation data obtained from one or more inverters connected to the plurality of solar PV panels, and (ii) forecasted solar PV power generation data generated by applying a third LSTM-RNN DL technique to historical solar PV power generation data.

7. The computer-implemented method of claim 3, wherein the ESS remaining useful life (RUL) prediction data is subdivided into: (i) ESS capacity degradation estimation data generated by using a second ANN ML model to estimate a battery capacity degradation cycle for each discharge cycle, and (ii) ESS RUL prediction data generated by a fourth LSTM-RNN DL technique to historical ESS capacity degradation data.

8. The computer-implemented method of claim 3, wherein the electricity price data is subdivided into: (i) real-time electricity price data obtained from the primary power grid on a recurring basis after a second predefined time period passes, (ii) upcoming electricity price forecast data generated at least once a day for the upcoming time window based on historical electricity price data, and (iii) demand response event data received from the primary power grid via one or more application programming interfaces (APIs).

9. The computer-implemented method of claim 1, wherein each agent in the deep reinforcement learning (DRL) platform is configured to apply a combination of deep learning (DL) and reinforcement learning (RL) machine learning (ML) techniques, wherein each agent is trained to make decisions by continuously interacting with an environment, wherein each agent starts with a random policy and receives either positive or negative feedback for every action taken by the agent, wherein each agent is configured to maximize positive feedback and to minimize negative feedback.

10. The computer-implemented method of claim 9, wherein each action taken by one of the agents in the DRL platform is framed as a Markov decision process (MDP).

11. A computer program product residing on a non-transitory computer readable medium having a plurality of instructions stored thereon which, when executed by a processor, cause the processor to perform operations comprising:
receiving energy input data from a plurality of microgrid sources;
using a prediction and forecasting platform to apply a combination of neural network models to the received energy input data in order to generate an input set of energy forecast data;
feeding the generated input set of energy forecast data into a deep reinforcement learning (DRL) platform including a real-time agent, a scheduling agent, and a demand response (DR) agent;
using the scheduling agent to create a schedule for load balancing activities in a microgrid and for utilization of an energy storage system (ESS) in an upcoming time-window;
using the real-time agent to update decisions for load balancing activities in the microgrid and for utilization of the ESS, on a recurring basis after a first predefined time period passes; and
in response to a DR event, using the DR agent to govern decisions for curtailment handling activities performed in the microgrid for the duration of the DR event.

12. The computer program product of claim 11, wherein the plurality of microgrid sources include the ESS, a plurality of electric-vehicle (EV) charging stations, a plurality of solar photovoltaic (PV) panels, one or more facility buildings, and a connection to a primary power grid.

13. The computer program product of claim 12, wherein the input set of energy forecast data includes EV charging demand data, facility usage forecast data, solar PV power generation forecast data, ESS remaining useful life (RUL) prediction data, and electricity price data.

14. The computer program product of claim 13, wherein the EV charging demand data is subdivided into (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory recurrent neural network (LSTM-RNN) deep learning (DL) technique to forecast how many cars will attempt to charge in the upcoming time-window, and how much power will be demanded by them.

15. The computer program product of claim 11, wherein each agent in the deep reinforcement learning (DRL) platform is configured to apply a combination of deep learning (DL) and reinforcement learning (RL) machine learning (ML) techniques, wherein each agent is trained to make decisions by continuously interacting with an environment, wherein each agent starts with a random policy and receives either positive or negative feedback for every action taken by the agent, wherein each agent is configured to maximize positive feedback and to minimize negative feedback.

16. A computing system comprising:
a memory; and
a processor configured to receive energy input data from a plurality of microgrid sources, use a prediction and forecasting platform to apply a combination of neural network models to the received energy input data in order to generate an input set of energy forecast data, feed the generated input set of energy forecast data into a deep reinforcement learning (DRL) platform including a real-time agent, a scheduling agent, and a demand response (DR) agent, use the scheduling agent to create a schedule for load balancing activities in a microgrid and for utilization of an energy storage system (ESS) in an upcoming time-window, use the real-time agent to update decisions for load balancing activities in the microgrid and for utilization of the ESS, on a recurring basis after a first predefined time period passes, and in response to a DR event, use the DR agent to govern decisions for curtailment handling activities performed in the microgrid for the duration of the DR event.

17. The computing system of claim 16, wherein the plurality of microgrid sources include the ESS, a plurality of electric-vehicle (EV) charging stations, a plurality of solar photovoltaic (PV) panels, one or more facility buildings, and a connection to a primary power grid.

18. The computing system of claim 17, wherein the input set of energy forecast data includes EV charging demand data, facility usage forecast data, solar PV power generation forecast data, ESS remaining useful life (RUL) prediction data, and electricity price data.

19. The computing system of claim 18, wherein the EV charging demand data is subdivided into: (i) real-time EV power demand data generated when an EV requests power from one of the one or more EV charging stations, estimated EV charging demand data per charging session generated by using a first artificial neural network (ANN) machine learning (ML) model to consider make, model, and charge curve of the EV to be charged, geographic location, time of day, season, and weather, and (ii) forecasted EV charging demand data for the day generated by using a first long short-term memory-recurrent neural network (LSTM-RNN) deep learning (DL) technique to forecast how many cars will attempt to charge in the upcoming time-window, and how much power will be demanded by them.

20. The computing system of claim 16, wherein each agent in the deep reinforcement learning (DRL) platform is configured to apply a combination of deep learning (DL) and reinforcement learning (RL) machine learning (ML) techniques, wherein each agent is trained to make decisions by continuously interacting with an environment, wherein each agent starts with a random policy and receives either positive or negative feedback for every action taken by the agent, wherein each agent is configured to maximize positive feedback and to minimize negative feedback.
